(19) United States
(12) Patent Application Publication
(10) Pub. No.: US 2010/0106482 A1
(43) Pub. Date: Apr. 29, 2010

(54) ADDITIONAL LANGUAGE SUPPORT FOR TELEVISIONS

(75) Inventors: Robert Hardacker, Escondido, CA (US); Steven Richman, San Diego, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignees: Sony Corporation, Tokyo (JP); Sony Electronics Inc., Park Ridge, CA (US)

(21) Appl. No.: 12/257,331

(22) Filed: Oct. 23, 2008

(51) Int. Cl. G06F 17/28; H04N 11/00

(52) U.S. Cl. 704/3; 348/468; 348/E11.001

(57) ABSTRACT

Systems and methods to provide additional language support for televisions are described herein. In one embodiment, a video signal including a first data stream representing text in a first language is received. The first data stream is transmitted to a remote source for real time translation into a second data stream representing text in a second language. The second data stream is received and then, displayed. In another embodiment, an uncompressed stream is received from a set top box. The uncompressed stream includes a first closed caption data format, which is in a first language. The first closed caption data format is converted into a first closed caption data stream using optical character recognition. The first closed caption data stream which represents text in the first language, is sent to a remote source for translation into a second closed caption data stream which represents text in a second language. The second closed caption data stream is received and then, displayed. In yet another embodiment, an uncompressed stream is received from a set top box. The uncompressed stream includes a first electronic program guide data which is in a first language. The first electronic program guide data is converted into a first format recognized by optical character recognition. The electronic program guide data in the first format represents text in the first language. The first electronic program guide data is outputted in a first format for translation into an electronic program guide data having a second format. The electronic program guide data in the second format represents text in a second language. The electronic program guide data in the second format is received and then, displayed.

### FIELD OF THE INVENTION

Embodiments of the invention relate to language support for televisions and more particularly, a system allowing users to select additional languages for displaying closed captioning, electronic program guides, and internal menus.

### BACKGROUND

Conventional televisions provide support for two or three languages, typically, English, Spanish, and French. As our society has become increasingly multilingual, televisions should offer additional language support for users for whom English, Spanish, or French do not meet their needs.

Currently, televisions provide textual displays in the form of closed caption as well as interactive displays including electronic program guides or internal menus. The closed caption is text corresponding to the spoken audio information contained in the television signal which is displayed on the television screen. The electronic program guide is displayed on the television and allows users to view television program information and select a desired program. The internal menus allow users to navigate and set various options on their television.

It would be highly desirable to provide the closed captioning, the electronic program guides, and the internal menus in languages other than English, Spanish, and French. For example, a hearing-impaired user or a user whose first language is not English, Spanish, or French, would benefit from text displayed in his native language. Similarly, a user who is learning a new language can ameliorate his reading skills in that language by setting the system accordingly. In addition, it is common for users within one household to have differing language preferences. It would be useful to provide an apparatus and method that would allow the household television to be adaptable to the language preferences of each user.

Other features and advantages of the present invention will be apparent from the accompanying drawings and from the detailed description that follows below.

### SUMMARY OF THE DESCRIPTION

Embodiments of systems and methods to provide additional language support for televisions are described.

According to one embodiment of the invention, a method to provide additional language support for televisions includes receiving a video signal including a first data stream representing text in a first language. The first data stream is then transmitted to a remote source for real time translation into a second data stream representing text in a second language. The second data stream is received and then, displayed.

In another embodiment of the invention, a method includes receiving an uncompressed stream from a set top box. The uncompressed stream includes a first closed caption data format, which is in a first language. The first closed caption data format is converted into a first closed caption data stream using optical character recognition. The first closed caption data stream which represents text in the first language, is sent to a remote source for translation into a second closed caption data stream which represents text in a second language. The second closed caption data stream is received and then, displayed.

In one embodiment of the invention, the method includes receiving an uncompressed stream from a set top box. The uncompressed stream includes a first electronic program guide data which is in a first language. The first electronic program guide data is converted into a first format recognized by optical character recognition. The electronic program guide data in the first format represents text in the first language. The first electronic program guide data is outputted in a first format for translation into an electronic program guide data having a second format. The electronic program guide data in the second format represents text in a second language. The electronic program guide data in the second format is received and then, displayed.

In yet another embodiment of the invention, a system to provide additional language support for televisions includes a digital device to receive a video signal including a first data stream which represents text in a first language and a remote source to receive the first data stream from the digital device. The remote source translates the first data stream in real time into a second data stream which represents text in a second language. The remote source also sends the second data stream to the digital device to be displayed.

Additional embodiments may include identifying a program being viewed by referencing the electronic program guide data. For instance, the program may be identified by any combination of the following factors: current time, an approximate physical location, a selected channel and/or a service provider.

According to another embodiment of the invention, the remote source includes a set top box to monitor the content being received and extract the first data which represents text in a first language. The remote source receives content from a content provider including the first data which may be the closed caption data. Upon receiving a request from a digital device for a second data which represents text in a second language, the remote source generates a translation in real time of the first data into the second data. The remote source then sends the second data to the digital device to be rendered. In one embodiment, the remote source receives a first data stream which may be the closed caption stream in a first language.

In another embodiment of the invention, the remote source generates a database of the first data received from the content provider. The digital device sends a request for translation of a program's closed caption to the server. The remote source then searches the database for the requested program. In one embodiment, if the program is available, the remote source generates a translation of the closed caption for the entire program and sends the translation to the digital device to be stored and displayed in a synchronous manner. In another embodiment, the remote source streams the translation of the closed caption data to the digital device to be displayed in a synchronous manner.

According to one embodiment of the invention, the remote source receives a digital audio stream in a first language from the digital device. The remote source converts the digital audio stream into a text stream in a first language and translates both the audio and text streams into a second language. In another embodiment, the remote source may directly translate the audio stream in a first language to an audio stream and text stream in a second language without converting the audio stream in a first language into text.

In another embodiment of the invention, the remote source receives a program identifier and a position within the program. The position within the program may be a time stamp or other location indicator. It is also contemplated that the remote source may source the audio stream or a closed caption stream or search within the database for the text of a program's script.

According to some embodiments, the remote source has direct access to the content providers' electronic program guide data. The set top box included in the remote source may, for example, be tuned to the electronic program guide data. It is also contemplated that the remote source may have a subscription to that electronic program guide provider. Accordingly, when the remote source receives a request from the digital device for translation of an electronic program guide, the remote source may acquire the identification of the electronic program guide which may include receiving an identification of the location of the electronic program guide, the content provider, and the time. The remote source then sources the electronic program guide data directly from the content provider or from the remote source's own set top box tuned to the electronic program guide data. Alternatively, the remote source may also source the electronic program guide data using an internet subscription. The remote source then translates the electronic program guide data to represent text in a second language and sends the translated electronic program guide data to the digital device to be rendered.

The above summary does not include an exhaustive list of all aspects or embodiments of the present invention. It is contemplated that the invention includes all systems and methods that can be practiced from all suitable combinations of the various aspects summarized above, as well as those disclosed in the Detailed Description below and particularly pointed out in the claims filed with the application. Such combinations may have particular advantages not specifically recited in the above summary.

### BRIEF DESCRIPTION OF THE DRAWINGS

The embodiments of the invention are illustrated by way of example and not by way of limitation in the figures of the accompanying drawings in which like references indicate similar elements. In the drawings:

FIG. 1 is an exemplary block diagram of a content delivery system consistent with certain embodiments of the invention.

FIG. 2 is an exemplary block diagram of a digital device obtaining additional language support according to an embodiment of the invention.

FIG. 3 is an exemplary block diagram of a digital device obtaining additional language support according to an embodiment of the invention.

FIG. 4 is an exemplary block diagram of a digital device obtaining additional language support according to an embodiment of the invention.

FIG. 5 is an illustrative flowchart of a process for obtaining additional language support according to an embodiment of the invention.

FIG. 6 is an illustrative flowchart of a process for obtaining additional language support for the closed caption according to an embodiment of the invention.

FIG. 7 is an illustrative flowchart of a process for obtaining additional language support for the electronic program guide according to an embodiment of the invention.

### DETAILED DESCRIPTION

In the following description, numerous specific details are set forth. However, it is understood that embodiments of the invention may be practiced without these specific details. In other instances, well-known circuits, structures, and techniques have not been shown to avoid obscuring the understanding of this description.

References in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily refer to the same embodiment.

One embodiment of the invention may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged.

The algorithms and displays presented herein are not inherently related to any particular computer or other apparatus. For the purposes of the present description, the term “digital device” may refer to a television that is adapted to tune, receive, decrypt, descramble and/or decode transmissions from any content provider. However, it is contemplated that the “digital device” may constitute any general-purpose system which may be used with programs in accordance with the teachings herein. For instance, the digital device may be of another form factor besides a television, such as a set-top box, a personal digital assistant (PDA), a computer, a cellular telephone, a video game console, a portable video player such as a SONY® PSP® player, a digital video recorder, or the like. Examples of “content providers” may include a terrestrial broadcaster, a cable or satellite televisions distribution system, or a company providing content for download over the Internet or other Internet Protocol (IP) based networks such as an Internet service provider.

In the following description, certain terminology is used to describe features of the invention. For example, in certain situations, the terms “component,” “unit” and “logic” are representative of hardware and/or software configured to perform one or more functions. For instance, examples of “hardware” include, but are not limited or restricted to an integrated circuit such as a processor (e.g., a digital signal processor, microprocessor, application specific integrated circuit, a microprocessor, application specific integrated circuit, a microcontroller, etc.). Of course, the hardware may be alternatively implemented as a finite state machine or even combinatorial logic.

As an example of “software” includes executable code in the form of an application, an applet, a routine or even a series of instructions. The software may be stored in any type of machine readable medium such as a programmable electronic circuit, a semiconductor memory device such as volatile memory (e.g., random access memory, etc.) and/or non-volatile memory (e.g., any type of read-only memory “ROM”, flash memory, et.), a floppy diskette, an optical disk (e.g., compact disk or digital video disc “DVD”), a hard drive disk, a tape, or the like.

In addition, the term “program” generally represents a stream of digital content that is configured for transmission to one or more digital devices for viewing and/or listening. According to one embodiment, the program may contain MPEG (Moving Pictures Expert Group) compliant compressed video although other standardized formats may be used.

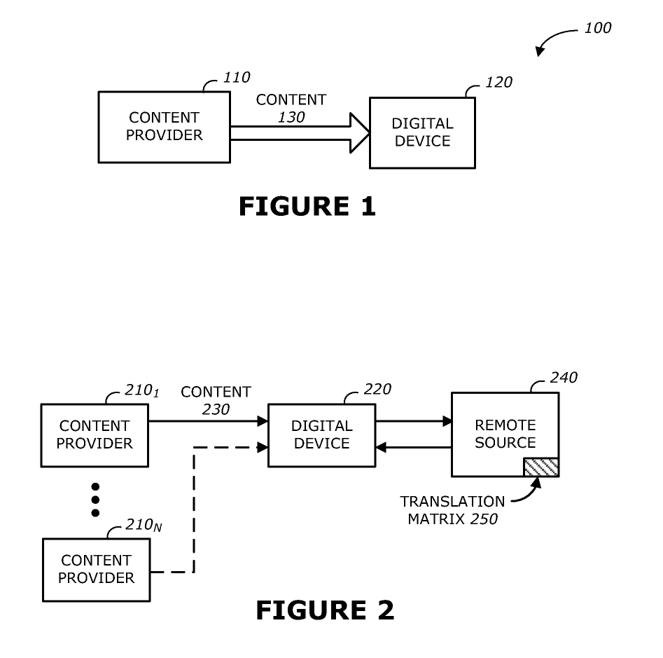

FIG. 1 shows an exemplary block diagram of a content delivery system consistent with certain embodiments of the invention. Content delivery system 100 comprises a digital device 120 that receives digital content such as a program from one or more content providers 110. The program may be propagated as a digital data stream for example in compliance with any data compression scheme. Examples of a data compression scheme include, but are not limited or restricted to MPEG standards.

Content provider 110 provides the digital content to digital device 120 through a transmission medium 130, which operates as a communication pathway for the program within content delivery system 100. The transmission medium 130 may include, but is not limited to electrical wires, optical fiber, cable, a wireless link established by wireless signaling circuitry, or the like.

FIG. 2 is an exemplary block diagram of a digital device obtaining additional language support according to an embodiment of the invention. The system includes a digital device 220 that receives digital content from one or more content providers 210₁-210_{N} (N≧1 as represented by dashed lines) through a transmission medium 230. In this system, the digital content which is a video signal includes the data stream in a first language. A remote source 240 receives the digital content from the digital device 220. The remote source 240 translates the data stream in a first language in real time into a data stream in a second language. In one embodiment, the remote source 240 includes a translation matrix 250 used to perform the real time translation. The remote source 240 then sends the data stream in a second language back to the digital device 220 to be displayed. In one embodiment, the data stream in a first language and the data stream in a second language are ASCII digital data.

In one embodiment, the data stream is closed caption data. Accordingly, the closed caption data stream in a first language is received by the remote source 240 to be translated into a closed caption data stream in a second language. In one embodiment, the data stream is an electronic program guide data. The electronic program guide provides a schedule of the television programming. Similarly, the electronic program guide data in a first language is received and translated by the remote source 240 into an electronic program guide data in a second language.

According to one embodiment, the first language is the language of the closed caption or the electronic program guide which is being provided by content provider 210ᵢ (1≧i≧N). For example, if the video stream includes a program which is in English, the content providers will likely provide the closed captioning for that program in English. Similarly, if, for example, the content provider mainly services the United States, the electronic program guide will likely be provided in English. In both these examples, the first language would be English.

The second language may be selected based on a specific user's preference or based on a household's preference. For example, if a user's primary language is Vietnamese but wishes to watch an English program, the user may set the second language to be Vietnamese. Accordingly, while the content provider sends the closed caption of a program or an electronic program guide to the digital device in English, the closed caption or the electronic program guide in English may be transmitted for translation into Vietnamese.

Since each user may have set a different second language, the data in the first language should be translated to the second language corresponding to the user's preference. There are numerous methods for the digital device to establish the appropriate second language. For instance, according to one embodiment, the second language may be selected by the user using a remote control. For example, the user may use the remote control to enter the desired language or select the desired language within a list of possible languages. Identifiers including but not limited to nicknames, codes, numbers, and letters may also be used. In another embodiment, identifiers corresponding to each user's personalized language settings are displayed to be selected by a user. The personalized language settings include the second language which was previously set by the detected user. Otherwise, the user may be prompted to input an identifier which activates the user's personalized language settings. The identifiers may be selected or inputted using the remote control. In yet another embodiment, the user is detected biometrically and the personalized language settings having a setting for the detected user are loaded. For example, the remote control may include fingerprint detector which detects the user based on his fingerprint. Upon detecting the user, the digital device loads the personal language settings associated with that detected user. Accordingly, the second language which was previously set by the detected user is loaded.

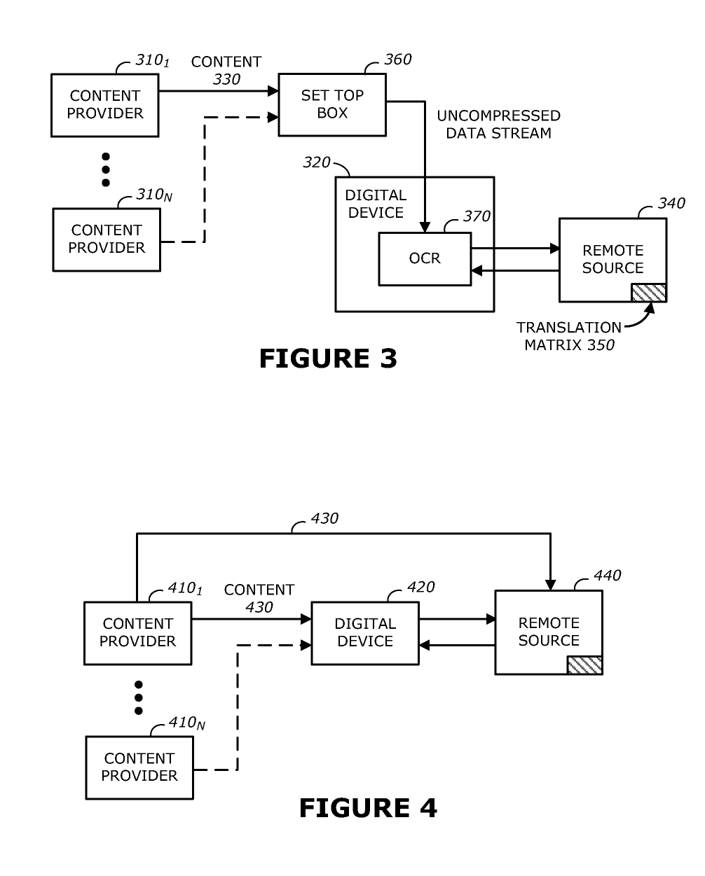

FIG. 3 is an exemplary block diagram of a digital device obtaining additional language support according to an embodiment of the invention. The system includes a set-top box 360 that receives digital content from one or more content providers 310₁-310_{N} (N>1) through a transmission medium 330. The digital device 320 receives an uncompressed stream from the set-top box 360. In this system, the uncompressed stream includes a data in a first language. Accordingly, the data in the first language is converted into a first data stream using optical character recognition 370. The first data stream represents text in the first language. A remote source 340 receives the first data stream from the digital device 320. The remote source 340 translates the first data stream into a second data stream which represents text in a second language. In one embodiment, the remote source 340 includes a translation matrix 350 used to perform real time translation of the first data stream into the second data stream. The remote source 340 then sends the data stream in a second language back to the digital device 320 to be displayed. In one embodiment, the data stream in a first language and the data stream in a second language are ASCII digital data.

In one embodiment, the uncompressed stream includes data which is closed caption data in a first language. In one embodiment, the uncompressed stream includes data which is the electronic program guide data in a first language. Accordingly, the digital device 320 may receive the closed caption data and/or the electronic program guide data as part of the uncompressed stream sent by the set-top box 360.

FIG. 4 an exemplary block diagram of a digital device obtaining additional language support according to an embodiment of the invention. The system includes a digital device 420 that receives digital content from one or more content providers 410₁-410_{N} (N≧1) through a transmission medium 430. In this system, a remote source 440 also receives digital content from the one or more content providers 410₁-410_{N}.

In one embodiment, the content, which may be a video stream, is monitored using a set top box included in the remote source 440. The content may include, for example, a program being currently watched. In one embodiment, the remote source 440 acquires an identification of the program being viewed. In one embodiment, acquiring an identification of the program being viewed may include referencing the electronic program guide data. In another embodiment, acquiring the identification includes identifying the program by a combination of the current time, an approximate physical location, a selected channel and a service provider.

The content may also include a first data representing text in a first language. Using the set top box, the first data is extracted from the content. Upon receiving from the digital device 420 a request for translation, the remote source 440 may translate the extracted first data into a second data representing text in a second language in real time and stream the second data to the digital device 420 to be displayed.

In one embodiment, the first data included in the content sent from the one or more content providers 410₁-410_{N} to the remote source 440 is a closed caption data representing the text in a first language. In another embodiment, the remote source 440 receives a closed caption stream directly from the one or more content providers 410₁-410_{N}. Upon receiving request for translation from the digital device 420, the remote source 440 generates a real time translation of the closed caption stream into a second language and sends the translated closed caption stream to the digital device 420 for rendering.

In one embodiment, the remote source 440 generates a database of either (i) closed caption data extracted from the content using the set top box or (ii) closed caption stream provided directly from the one or more content providers 410₁-410_{N}. Accordingly, when the remote source 440 receives a request for translation of a program from the digital device 420, the remote source 440 searches the database for the program. If the program is available in the database, the remote source 440 generates a translation of the entire program's extracted closed caption data or the entire program's closed caption stream. In one embodiment, the remote source 440 then sends the translation of the entire program's closed caption data or closed caption data stream to the digital device 420 as well as time stamps to be stored as a complete file. In this embodiment, the digital device 420 renders the translated closed caption data or stream along with the program. It is also contemplated that the digital device 420 may render the closed caption data or stream per time stamp or other synchronous indicating manner. In another embodiment, the remote source 440 streams the translated closed caption data or stream to the digital device 420 in a synchronous manner.

According to some embodiments, the first data included in the content sent by the one or more content providers 410₁-410_{N} is an electronic program guide data in a first language. The remote source 440 may have direct access to the electronic program guide data for one or more content providers 410₁-410_{N}. In one embodiment, the remote source 440 includes a set top box which may be tuned to the electronic program guide data. In another embodiment, one of the content providers 410₁-410_{N} is an electronic program guide provider and the remote source 440 has a subscription to that electronic program guide provider. In this embodiment, the remote source 440 receives the first data being an electronic program guide in a first language from the electronic program guide provider. When the remote source 440 receives a request from the digital device 420 for translation of the electronic program guide, the remote source 440 acquires the identification of the electronic program guide.

According to one embodiment of the invention, acquiring the identification of the electronic program guide includes receiving an identification of the location of the electronic program guide, the content provider 410ᵢ (1<i<N), and the time. Accordingly, the remote source 440 sources the electronic program guide data directly from the content provider or from the remote source's 440 own set top box tuned to the electronic program guide data. Alternatively, the remote source 440 may also source the electronic program guide data using an internet subscription. The remote source 440 then translates the electronic program guide data to represent text in a second language and sends the translated electronic program guide data to the digital device 420 to be rendered.

In order to ensure proper rendering of the text in a second language on the digital device, it is contemplated that the remote source 440 may provide a font download to the digital device if a non-alphanumeric alphabet is required.

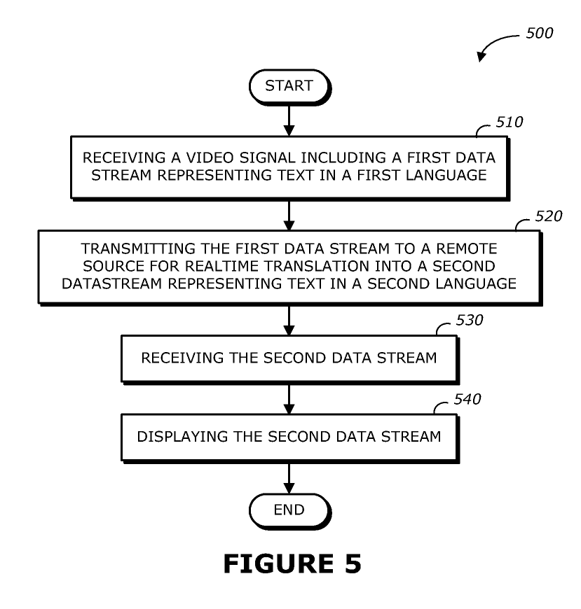

FIG. 5 is a flowchart of one embodiment of method 500 for obtaining additional language support for closed caption and for the electronic program guide according to an embodiment of the invention. Method 500 begins by receiving a video signal (Block 510). The video signal which may be sent from a content provider includes a first data stream which represents text in a first language. The data stream may be closed caption data or electronic program data. Next, the first data stream is transmitted to a remote source for real time translation into a second data stream (Block 520). The second data stream represents text in a second language. In one embodiment, the first and second data streams are ASCII digital data. The second data stream is then received from the remote source (Block 530) and subsequently, displayed (Block 540). In one embodiment, the second data stream may be displayed on a digital device.

In an alternative embodiment, in lieu of sending the first data stream from the digital device to the remote source, the digital audio stream included in the video signal is sent from the digital device to the remote source. At the remote source, the digital audio stream which is in a first language is converted to a text data in the first language. The remote source then translates the audio and text data into a second language and sends the translated audio and text to the digital device for rendering. It is also contemplated that the remote source may receives the digital audio stream from the digital device to be translated into a second language without first converting the digital audio stream to text data. The remote source then returns to the digital device a translated text as well as a translated audio stream.

In yet another alternative embodiment, the remote device may receive a program identification and a position within the program. The position within the program may be indicated by a time stamp or other location indicator. As discussed above, the remote source may then, for example, (i) receive the digital audio stream from a content supplier or from a digital device, or (ii) receive the closed caption data or closed caption stream from the content supplier or from a digital device, or (iii) even generate a database containing the text of an entire show received from a content supplier. In one embodiment, the remote source translates the data in a first language into data in a second language using other sources of audio. In one embodiment, the remote source sends the translated audio stream, closed caption data or stream, or text to the digital device for rendering.

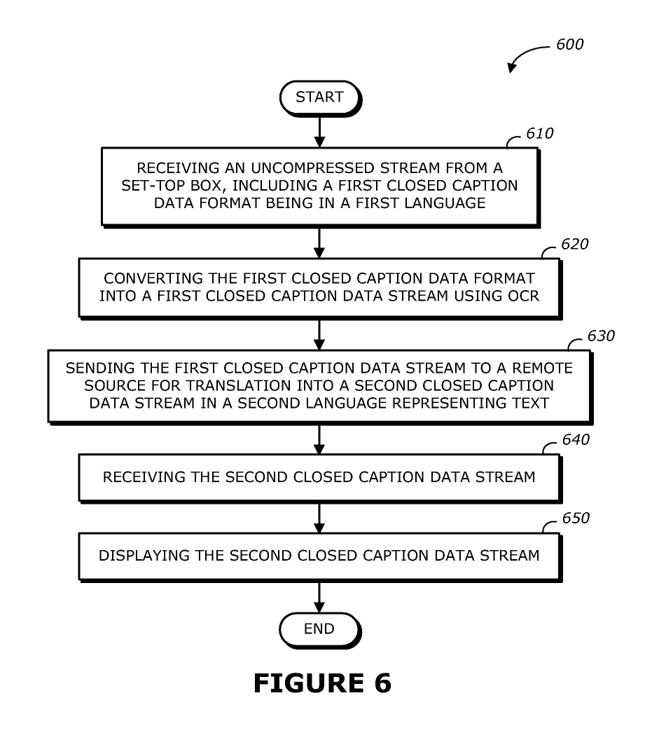

FIG. 6 is a flowchart of one embodiment of method 600 for obtaining additional language support for the closed caption according to an embodiment of the invention. The method 600 starts by receiving an uncompressed stream from a set top box (Block 610). The uncompressed stream includes a first closed caption data format which is in a first language. The first closed caption data format may be displayed in a closed caption data window including characters in a first language. For example, the closed caption window may be a box or window of color containing text in a high contrast color. The first closed caption data format is converted into a first closed caption data stream using optical character recognition (Block 620). The first closed caption data stream represents text in the first language. The conversion using optical character recognition may comprise determining the closed caption window and detecting the characters in a first language. For example, the digital device would recognize the box or window of color and identify the text. The first closed caption data stream is sent to a remote source for translation into a second closed caption data stream which represents text in a second language (Block 630). In one embodiment, the first closed caption data stream and second closed caption data stream are ASCII digital data. The second closed caption data stream is received from the remote source (Block 640) and subsequently, is stored and/or displayed (Block 650). The second closed caption data stream may be displayed by generating a graphics plane window including characters in the second language corresponding to the second closed caption data stream and overlaying the closed caption window with the graphics plane window. Alternatively, the second caption data stream may be rendered on a secondary display such as an RF enabled remote control.

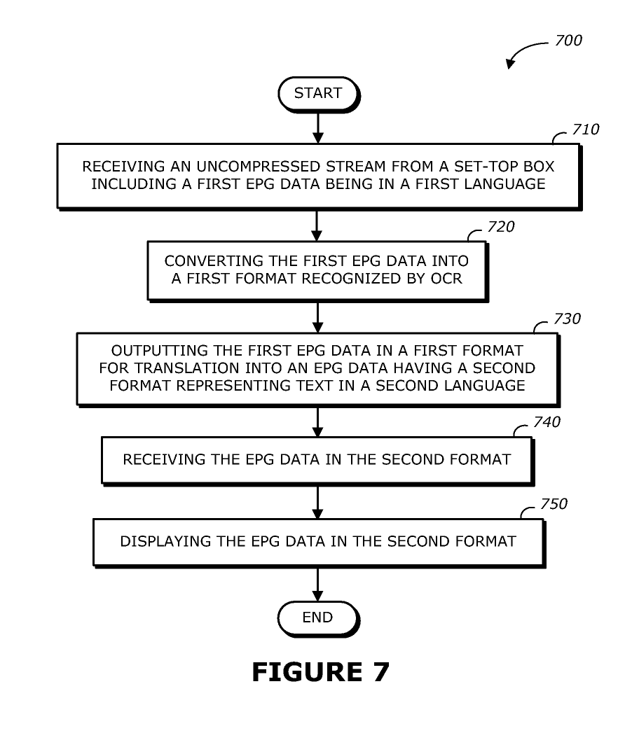

FIG. 7 is a flowchart of one embodiment of method 700 for obtaining additional language support for the electronic program guide according to an embodiment of the invention. Method 700 starts by receiving an uncompressed stream from a set top box (Block 710). The uncompressed stream includes a first electronic program guide data which is in a first language. The first electronic program guide data may be displayed on a screen including characters in the first language. The first electronic program guide data is converted into a first format recognized by optical character recognition (Block 720). The electronic program guide data in the first format represents text in the first language. Converting the first electronic program guide data may include detecting the characters in the first language.

Therefore, the first electronic program guide data in a first format is outputted for translation into an electronic program guide data having a second format (Block 730). The electronic program guide data in the second format represents text in a second language. In one embodiment, the electronic program guide data in the first format and electronic program guide data in a second format are ASCII digital data. Next, the electronic program guide data in the second format is received from a remote source and is stored and/or displayed (Block 740 and 750). According to one embodiment of the invention, at block 750, the screen may be blanked and an electronic program guide including characters in the second language corresponding to the second electronic program guide data stream may be displayed. Alternatively, at block 750, the electronic program guide including characters in the second language may be rendered on a secondary display such as an RF enabled remote control or the electronic program guide including characters in the second language may be displayed either on a picture-in-picture, in a twin picture mode, or on a window at the top or bottom of the screen.

With respect to the internal menus provided in the digital devices, additional language support may also be provided. The digital device may provide the user with the option to request the additional language modules. For example, the traditional language modules included on the digital devices include English, French, and Spanish. However, if the user desires to have the internal menus on his digital device in Turkish, for example, he may request Turkish language module. The user may request the module using a remote control to input the desired language or to select among a list of available additional language modules being displayed on the digital device's screen. Upon receiving the request for the additional language module, the digital device may download the appropriate module from a remote source. The user may only have to request the additional language module one time. In lieu of receiving additional language modules from a cable provider, it is contemplated that the additional language modules may also be available online for downloading.

Additionally, the personalized language settings as provided herein may include separate settings for the closed caption, the electronic program guide, and the internal menus. Accordingly, a user does not have to set the desired language of the closed caption to be the same as that of the electronic program guide.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting. There are numerous other variations to different aspects of the invention described above, which in the interest of conciseness have not been provided in detail. Accordingly, other embodiments are within the scope of the claims.

What is claimed is:

1. A method comprising:
receiving a video signal including a first data stream representing text in a first language;
transmitting the first data stream to a remote source for real time translation into a second data stream representing text in a second language;
receiving the second data stream; and
displaying the second data stream.

2. The method of claim 1, wherein the video signal is sent from a content provider.

3. The method of claim 1, wherein the first data stream is closed caption data in a first language and the second data stream is closed caption data in a second language.

4. The method of claim 1, wherein the first data stream is an electronic program guide data in a first language and the second data is electronic program guide data in a second language.

5. The method of claim 1, wherein the first data stream and second data stream are ASCII digital data.

6. The method of claim 1, wherein displaying the second data stream further comprises:
displaying the second data stream on a digital device.

7. The method of claim 1, wherein the second language is selected by a user using a remote control.

8. The method of claim 1, further comprising:
displaying one or more identifiers to be selected by a user, the one or more identifiers corresponding to personalized language settings, wherein the personalized language settings include a setting for the second language being set by the user.

9. The method of claim 1, further comprising:
detecting a user biometrically; and
loading the personalized language settings, the personalized language settings having a setting for the detected user including the second language being previously set by the detected user.

10. The method of claim 1, further comprising:
prompting a user to input an identifier, the identifier activating the user's personalized language settings, the personalized language settings include a setting for the second language being previously set by the user.

11. A method comprising:
receiving an uncompressed stream from a set top box, the uncompressed stream including a first closed caption data format, the first closed caption data format being in a first language;
converting the first closed caption data format into a first closed caption data stream using optical character recognition, the first closed caption data stream representing text in the first language;
sending the first closed caption data stream to a remote source for translation into a second closed caption data stream, the second closed caption data stream representing text in a second language;
receiving the second closed caption data stream; and
displaying the second closed caption data stream.

12. The method of claim 11, wherein the first closed caption data format is displayed in a closed caption data window including characters in a first language.

13. The method of claim 12, wherein converting the first closed caption data format using optical character recognition comprises:
determining the closed caption window; and
detecting the characters in a first language.

14. The method of claim 13, wherein displaying the second closed caption data stream comprises:
generating a graphics plane window including characters in the second language corresponding to the second closed caption data stream; and
overlaying the closed caption window with the graphics plane window.

15. The method of claim 11, wherein the second language is selected by a user using a remote control.

16. The method of claim 11, further comprising:
displaying one or more identifiers to be selected by a user, the one or more identifiers corresponding to personalized language settings, wherein the personalized language settings include a setting for the second language being set by the user.

17. The method of claim 11, further comprising:
detecting a user biometrically; and
loading personalized language settings, the personalized language settings having a setting for the detected user including the second language being previously set by the detected user.

18. The method of claim 11, further comprising:
prompting a user to input an identifier, the identifier activating the user's personalized language settings, the personalized language settings include a setting for the second language being previously set by the user.

19. The method of claim 11, wherein the first closed caption data stream and second closed caption data stream are ASCII digital data.

20. A method comprising:
receiving an uncompressed stream from a set top box, the uncompressed stream including a first electronic program guide data, the first electronic program guide data being in a first language;
converting the first electronic program guide data into a first format recognized by optical character recognition, the electronic program guide data in the first format representing text in the first language;
outputting the first electronic program guide data in a first format for translation into an electronic program guide data having a second format, the electronic program guide data in the second format representing text in a second language;
receiving the electronic program guide data in the second format; and
displaying the electronic program guide data in the second format.

21. The method of claim 20, wherein the first electronic program guide data is displayed on a screen including characters in the first language.

22. The method of claim 21, wherein converting the first electronic program guide data into a first format recognized by optical character recognition comprises:
detecting the characters in the first language.

23. The method of claim 22, wherein displaying the electronic program guide data in the second format comprises:
blanking the screen; and
displaying on the blank screen an electronic program guide including characters in the second language corresponding to the second electronic program guide data stream.

24. The method of claim 20, wherein the second language is selected by a user using a remote control.

25. The method of claim 20, further comprising:
displaying one or more identifiers to be selected by a user, the one or more identifiers corresponding to personalized language settings, wherein the personalized language settings include a setting for the second language being set by the user.

26. The method of claim 20, further comprising:
detecting a user biometrically; and
loading personalized language settings, wherein the personalized language settings having a setting for the detected user including the second language being previously set by the detected user.

27. The method of claim 20, further comprising:
prompting a user to input an identifier, the identifier activating the user's personalized language settings, the personalized language settings include a setting for the second language being previously set by the user.

28. The method of claim 20, wherein the electronic program guide data in the first format and electronic program guide data in a second format are ASCII digital data.

29. A system comprising:
a digital device to receive a video signal including a first data stream, the first data stream representing text in a first language; and
a remote source to receive the first data stream from the digital device, the remote source to translate the first data stream in real time into a second data stream, the second data stream representing text in a second language, and the remote source to further send the second data stream to the digital device to be displayed.

30. The system of claim 29, wherein the video signal is sent from a content provider.

31. The system of claim 29, wherein the first data stream is a closed caption data stream in a first language and the second data is closed caption data stream in a second language.

32. The system of claim 29, wherein the first data is an electronic program guide data stream in a first language and the second data is electronic program guide data stream in a second language.

33. The system of claim 29, wherein the second language is selected by a user using a remote control.

34. The system of claim 29, wherein the digital device displays one or more identifiers to be selected by a user, the one or more identifiers corresponding to personalized language settings including a setting for the second language being set by the user.

35. The system of claim 29, wherein the digital device further comprises:
means to detect a user biometrically; and
means to load personalized language settings, the personalized language settings having a setting for detected user including the second language being previously set by the detected user.

36. The system of claim 29, wherein the digital device displays a screen prompting a user to input an identifier, the identifier activating the user's personalized language settings, the personalized language settings include a setting for the second language being previously set by the user.

37. The system of claim 29, wherein the first data stream and second data stream are ASCII digital data.

38. A method comprising:
receiving at a remote source (i) content from a content provider and (ii) identification of the content, the content including a first data representing text in a first language;
monitoring the content using a set top box included in the remote source; extracting the first data using the set top box;
receiving a request at the remote source from a digital device for a second data representing text in a second language;
translating at the remote source the extracted first data in real time into the second data; and
sending the second data from the remote source to the digital device to be displayed.

39. The method of claim 38 wherein the content may include a first closed caption data stream representing text in a first language.

40. The method of claim 38 further comprises generating a database including the extracted first data.

41. The method of claim 40, wherein translating the extracted first data includes translating the first data of a complete program into the second data, the second data includes time stamps.

42. The method of claim 41, further comprises storing the second data in the digital device.

43. The method of claim 41, further comprises rendering the second data per time stamp or other synchronous indicating manner.

44. The method of claim 40, wherein sending the second data includes streaming the second data to the digital device in a synchronous manner.

45. A method comprising:
receiving a first digital audio stream from a digital device, the first digital audio stream being in a first language;
converting the first digital audio stream to a first text stream, the first text stream being in the first language;
translating the first digital audio stream and the first text stream in real time to a second digital audio stream and a second text stream, the second audio stream and the second text stream being in a second language; and
sending the second audio stream and the second text stream to the digital device for rendering.
